(19) United States
(12) Patent Application Publication
(10) Pub. No.: US 2003/0093478 A1
(43) Pub. Date: May 15, 2003

(54) Collaboration and innovation system

(75) Inventor: Larry James Hughes, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/293,829

(22) Filed: Nov. 13, 2002

Related U.S. Application Data
(60) Provisional application No. 60/338,212, filed on Nov. 13, 2001.

(51) Int. Cl. G06F 17/60

(52) U.S. Cl. 709/205; 705/37

(57) ABSTRACT

A collaboration and innovation system that creates a virtual entrepreneurial work space and facilitates individual and group innovation efforts to solve problems and/or create intellectual property and/or create business opportunities is described. The system facilitates innovation efforts being done in response to stated problems and/or opportunities identified in the system and/or business ideas coming from members of the system network.

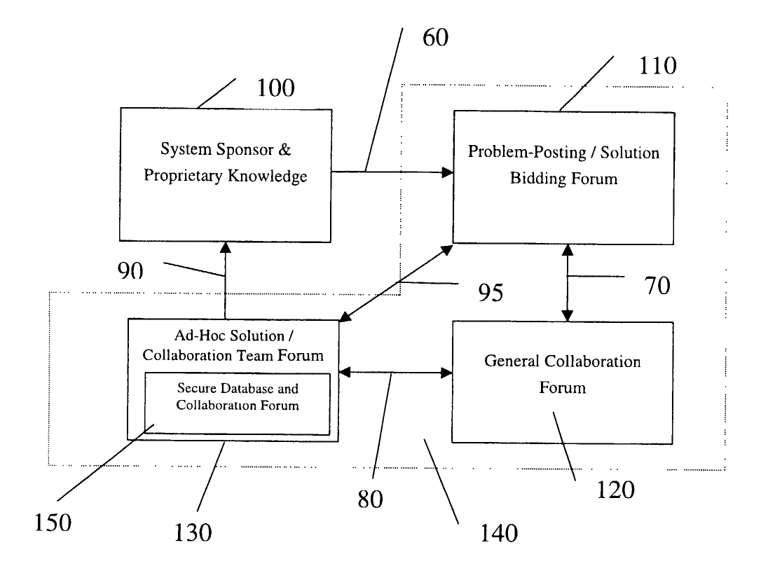

### CROSS-REFERENCE TO RELATED APPLICATION

This application claims priority to U.S. Provisional Patent Application Ser. No. 60/338,212, filed Nov. 13, 2001.

### FIELD OF THE INVENTION

This invention relates to collaboration systems having both data, information and knowledge sharing and team forming capabilities. The system provides a single integrated tool which allows for data, information and knowledge sharing, location of personnel with desired expertise, and problem solving by solution teams which may be formed on an ad-hoc basis among users of the system.

### BACKGROUND OF THE INVENTION

The past several years have been characterized by extraordinary growth in the magnitude and capabilities of interactive networks, particularly computer networks. These networks have provided a variety of capabilities often referred to generically in the literature as “connectivity.” A whole industry has emerged to develop and improve upon practical applications that take advantage of the connectivity these networks provide. One particular area of focus is in the area of collaboration systems.

Collaboration systems, may generally be thought of as any system which allows several persons to share, manipulate, and create data, information and knowledge among a group of users. Examples of a common collaboration tool include any of the commercially available email and data-sharing systems such as LOTUS NOTES or MICROSOFT OUTLOOK.

Because of the widespread availability of the World Wide Web and the ease with which HTTP (including HTML, and XML) based applications may be created and deployed among a variety of users, so-called “web based” applications have become a popular mechanism for the delivery of collaboration tools.

There are presently a number of web-based collaboration tools that are commercially available. These currently available systems have a wide variety of capabilities. For example, one product known as' E-ROOM (http://www.eroom.com) provides a collaboration system on the world wide web (or an html intranet) that allows for document sharing, creation of work teams, and organization of project team output.

Another presently available system is known as COPERNUS. This system provides a web based centralized “space” in which virtual teams can form. The system allows users to work across geographic and functional boundaries in an efficient manner. Users of the system can invite others to form teams in which data, information and knowledge may be shared in a “team space” visible to all team members.

Yet another system is presently available from Tacit (http://www.tacit.com). This system is designed to inventory the skills of users of the system (by input or automatically by electronic scanning of documents placed in the system by the users) in order to allow users to find other users having a certain set of skills or expertise.

There are also systems available which attempt to bring those having expertise to solve particular problems to those with a need for such expertise. For example, a system known as INNOCENTIVE (http://www.innocentive.com) allows users to post technical or scientific problems for which a solution is needed. Other users can then attempt to provide a solution to the problem in order to obtain a reward offered by the user posting the problem to be solved.

There are also systems available that allow registered users to access a database of funding opportunities and provide alerts to the registered users when new funding, of interest to the user, becomes available. COMMUNITY OF SCIENCE (http://www.cos.com) is one such system.

Generally, the currently available systems described above as well as others provide useful functionality. It has been found during development of the present invention that a need exists for an entrepreneurial and collaborative environment in which data, information and knowledge can be exchanged and innovation created. The past several years, have seen a marked increase in such entrepreneurial and collaborative environments as compared to prior times. It has been found during development of the present invention that such an environment can be fostered by a tool that allows a wide variety of people to interact in the manner required for such activity to occur efficiently.

### SUMMARY OF THE INVENTION

In its most basic form, the invention comprises an interactive system comprising a problem posting and solution bidding forum, a general forum, and a solution and collaboration forum. The problem posting and solution bidding forum, the general forum, and the solution and collaboration forum are operatively interconnected.

### BRIEF DESCRIPTION OF THE DRAWING

While the specification concludes with claims particularly pointing out and distinctly claiming the subject matter which is regarded as forming the present invention, it is believed that the invention will be better understood from the following description taken in conjunction with the accompanying drawing, in which:

The FIGURE is a block diagram representing the basic components of a system of the present invention.

### DETAILED DESCRIPTION OF THE INVENTION

This invention relates to collaboration systems having both data, information and knowledge sharing and team forming capabilities. In order to provide a more detailed understanding of the systems of the present invention, specific embodiments or executions of such systems will be described. These embodiments are meant to be representative and are not exhaustive examples of the manner in which the invention may be practiced.

Collaboration systems of the present invention may be provided using any suitable interactive technology. These systems may be provided through the use of one or more programmable computers. It has been found during the development of the present invention, that the use of standard HTMP (including HTML and XML) based World Wide Web systems as the vehicle through which to deliver the functionality of the described systems is suitable, although other vehicles are expected to work equally well. While there is great variation subsumed within the general descriptor “world wide web,” those of skill in the art will appreciate that using the teachings of this specification it is a routine matter to provide working systems which will work on a variety of known and commonly available computer systems and which will incorporate the features of the invention described herein.

The FIGURE is a block diagram that represents the basic components that may comprise a system of the present invention. It should be understood that these components shown and described are illustrative and that systems according to the present invention may have a configuration different from that shown in the FIGURE.

The FIGURE shows one example of a system of the present invention in which the various capabilities or components that comprise the system are contained within dashed line 140. Basic components that may comprise a system 140 of the present invention include a problem posting and/or solution bidding forum 1 10, a general collaboration forum 120 and an ad-hoc solution team forum 130 that may contain a secure data, information and knowledge exchange and collaboration forum, such as database and collaboration forum 150. These components may be provided as different “modules” within an integrated system, or could be provided as various types of functionality within a single interface. For example, different blocks of software, or even different host computers could be used for various components of the system 140 of the present invention. The various components should be functionality linked together so that users of the system can exchange data, information and knowledge with all components in an efficient an integrated manner, but the components need not be physically resident in a single location.

The inner workings of the components of the system 140 and the relationship between them will be described in greater detail below. First, however, some description regarding the various types of users who may interact with the system is necessary. The FIGURE shows a representation of a system sponsor 100. In general terms the system sponsor 100 may be thought of as the “system administrator” or “owner” of the system. The system sponsor 100 may be a single user or may refer collectively to a large group of users (such as personnel within a company). In addition to the system sponsor 100 other users may advantageously interact with the system of the present invention. All other users will collectively be referred to as “third-party” users in this specification. If the system 140 of the present invention is practiced in a web-based format on a publicly available network, then potentially anyone could be a third party user of such a system.

While one or more third party users may act as a system sponsor 100, conceptually all members of the public may be part of this group that interacts with the system 140 as a whole. This group may be completely public, such as any persons having access to the internet, or may be restricted by the system sponsor 100, in any desired manner. For example, the third party users of the system 140 may consist of retired employees of the system sponsor 100, a group of companies in a related industry, a group of academic communities, or any other identifiable group of otherwise non-connected persons.

Third party users, together with the system sponsor 100 can interact with the system 140 in any suitable manner. In one embodiment, such interactions may take place through programmable computers having a graphical user interface, such as an HTML coded web site. Of course, any other mechanism of interaction such as voice recognition, touch pads, or other suitable interfaces may also be used.

The present invention may be used to provide a mechanism through which the distributed talent, knowledge, and skills of a scattered and diverse population pool may be harnessed for business advantage. For example, a group of technically skilled, creative, business talented individuals may be known, but scattered, and not necessarily known to each other. Such groups could include retired R&D employees or one or more companies, persons holding particular educational training or work experience, or those who are members in various professional societies. There is a challenge in bringing the talent of such scattered and diverse groups of persons together for their mutual business advantage and/or for the benefit of a sponsoring or investing organization.

In recent years, great business and technical innovations have developed in a physical region generally referred to as “Silicon Valley.” During development of the present invention, it has been hypothesized that one reason for this highly successful business innovation is the ability of the talent pool, physically located in the region, to establish fluid working teams on an ad-hoc basis in order to create a business advantage. In other words, individuals working on problems in a particular field are frequently interacting with others in the general community. Because of the highly collaborative nature of this community, there is a likelihood that links will get made between individuals who may form working teams on a low-transaction cost basis. Such teams then quickly and efficiently can seek to create business-valuable solutions, techniques, and products that will have commercial value to the regional community at large. The Silicon Valley “network” provides a vehicle in which the desire for economic reward and the ability to form quick relationships with other appropriate members within the network facilities high levels of collaborative problem solving of an economically valuable nature.

The present invention seeks to capture the “Silicon Valley” network/collaboration model and remove the geographical restrictions. In other words, the system of the present invention may allow the identification of business opportunities, collaborative team forming and problem solving (innovation work) to occur in a manner independent of the location of the participating parties.

As noted above, basic components that may comprise a system 140 of the present invention include a problem posting and/or solution bidding forum 110, a general collaboration forum 120 and an ad-hoc solution team forum 130. The first of these basic components may be a problem posting and/or solution bidding forum 110, hereinafter referred to as the PP/SB forum. In general terms this PP/SB forum 110 may be thought of as the mechanism by which a market is established.

The PP/SB forum 110 may have a wide variety of functional capabilities and may take on any of a number of formats or characteristics. In one embodiment, the PP/SB forum 110 may consist of a database of specific technical challenges to be solved which are posted to the PP/SB forum 110 by the system sponsor 100 or any third party user of the system 140 (with or without the involvement of the system sponsor 100). In the FIGURE, such input to the PP/SB forum 10 is represented by input line 60 although, as noted, this is only one representation of many possible inputs to the PP/SB forum 110. In one variation, specific monetary or other incentives may be offered for the solution to one or more technical problems desired by the problem poster. Use of the PP/SB forum 110 is not limited to concrete, specific challenges. Problems of a more hypothetical nature, or a desire for a technological capability for which a practical application is not yet fully developed may also be included in this forum. The overall concept is to populate this section of the system with subject matter that would have actual or potential economic value to one or more users of the system. In this manner, all of the users of the system can determine those subject areas in which the users collectively have an interest in new technical development or contributions.

Elements of the PP/SB forum 110 may include: a database of problem and business opportunity postings that is categorized by a user relevant taxonomy which may also be full text searchable. A mechanism for the system sponsor 100 and/or authorized third party users to add/remove a problem or business opportunity to the database and track the number of times the entry is “viewed” by users of the system 140 may also be included. Problem and business opportunity postings may include: sufficient information about the problem or opportunity to allow user(s) of the system 140 to evaluate their potential to solve the problem and/or contribute to the solution or business creation; the remuneration the poster would pay for an accepted solution to the problem or the potential value for the business opportunity; a mechanism for the users to contact the problem or business opportunity poster and/or the sponsor 100 to enter into a collaboration agreement or obtain more information regarding the problem or opportunity; a mechanism to make known to other users of the system 140 a user's intent or willingness to engage in the development and/or submission of a solution for a given problem or opportunity. Potentially the posting would may also include the status of activities for the posting and/or who submitted the accepted solution to the problem or opportunity.

The PP/SB forum 110 may also include a mechanism for alerting a registered user when a problem or opportunity of interest to them was posted and/or when another user, such as a partial solution provider, solicited others to join in a solution development endeavor. The PP/SB forum 110 may also include a mechanism for establishing an agreement between the problem or opportunity poster and the solution provider(s) that includes, among other rights, the intellectual property rights to the solution. The PP/SB forum 110 could potentially contain a number of “links” to data, information, knowledge or resources that would be helpful to the problem/opportunity poster or solution provider, e.g. patent lawyers, patent offices such as the United States Patent and Trademark Office, registered system users database, etc. Additionally it is envisioned that some problems/opportunities may require, as part of the solution, physical prototypes or other evidence that is beyond the capability of the primary solution provider to create. In these cases it would be helpful for the PP/SB forum 110 to contain a listing of resources that have indicated there willingness to do work for a fee or a portion of the remuneration offered by the poster.

The second main component of the system 140 of the present invention may be the general collaboration forum 120 (hereinafter general forum). The general forum 120 utilizes the capabilities of known networking systems to foster open and extensive communication among the various users of the system 140. The general forum 120 may be linked to the other parts of the system, including, for example, the PP/SB forum 110. The linking of the PP/SB forum in combination with the general forum 120 may be advantageous. Without having to transition to another system or communication mechanism, members of the general community can begin to share ideas, generate discussion and solicit formation of an innovation team in view of general community knowledge (via the PP/SB forum 110, for example) regarding those areas in which the community is seeking new creation. This combination allows for the free exchange of data, information and knowledge and ideas in relatively open view of the incentives that the market (i.e. the PP/SB forum 110 portion of the system 140) is providing at any given point in time.

Any suitable format or set of functional characteristics or capabilities may be incorporated into the general forum 120. The general forum 120 may include a wide variety of public communication and collaboration techniques. These may include voice messaging, text messaging, both real time and “email” varieties, file sharing, multi-user audio and/or video conferencing (both central site and desktop), and other similar capabilities. A general forum 120 bulletin board feature may allow the sponsor 100, users and organizations to indirectly communicate a message, solicitation or announcement to members of the system 140 in a non-intrusive manner. The open conversations that are occurring in the general forum 120 may advantageously be categorized for example, via user relevant taxonomy and be full text searchable making it easy for users to find, track and participate in conversations of interest to them. Potentially, the general forum 120 may also facilitate the use of “peer to peer” file exchange technologies and services among the users.

Additionally, the general forum 120 may contain a database of individuals, registered users, and/or organizations that would like to engage in the exchange of data, information and knowledge and/or creation of innovations. User/organization information, profiles, would enable other users, organizations and the sponsor 100 to understand the expertise of the user/organization and the areas of collaboration the user/organization would find of interest. Additionally the profiles may potentially provide links to patents and/or publications of the user or organization as well as a mechanism for contacting the user or organization directly or via the sponsor 100.

One potential feature of the general forum 120 is a mechanism for alerting the sponsor 100, registered users, or organizations of activities that occur within the system or potentially outside the system, for example a user could be alerted when a conversation, of interest to them, is initiated in the general form 120 or when a problem/opportunity is posted in the PP/SB or when a call for collaboration is initiated or when a public “request for proposal”, RFP, is issued outside the system 140.

Another potential feature would be to directly link the general forum 120 to relevant resources to help the system users find and address opportunities, for example, academic institutions, government funding programs, contract manufactures, venture capitalists, etc.

The general forum 120 may assist in facilitation of the formation of Ad-Hoc collaboration/solution teams. The sponsor 100, registered users or organizations may desire to work with other parties in the system to develop a solution and/or address a business opportunity that is posted in the PP/SB or becomes evident via conversations in the general forum 120 or is publicized via the general forum 120 bulletin board. The solution/collaboration team may want their work to be private and secure from other parties both within and outside the system 140. A mechanism for soliciting membership in an Ad-Hoc team and access to a secure “solution/collaboration team forum 130” may, therefore, be provided in the general collaboration forum 120.

The third major component of the system 140 of the present invention may comprise an Ad-Hoc Solution/Collaboration Team forum 130 (hereinafter the S/C forum). Preferably the S/C forum 130 is integrally and operably connected with both the collaboration forum 120, and the PP/SB forum 110. The FIGURE shows a relationship in which the PP/SB forum 110, is connected to the general forum 120, through means 70, which in turn is connected to the S/C forum 130, through means 80. Additionally, means 95 may connect the S/C forum 130 to the PP/SB forum 110 representing an arrangement in which all three basic modules are integrally connected to each other allowing a user to freely move back and forth between them.

One distinction between the general forum 120 and the S/C 130 is that the S/C forum 130 is not generally accessible to all users of the system 140. In other words, while the general forum may be public (or at least as public as the system sponsor 100 sets up the entire system 140 to be), the S/C forum 130 may be more restricted. Preferably, the system 140 has the capacity to allow groups of users to create several S/C forum 130 areas simultaneously. These S/C forum 130 areas, may be “opened” by one or more users and populated with membership as desired by such users. The ability to access any opened S/C forum 130 may be limited to those who are invited by the user or users of the system who opened the particular S/C forum 130 in the first instance. The general forum 120 is designed to facilitate discussion and foster connection making in an area that is created in light of the market needs made visible by the PP/SB forum 110. This connection making then leads users of the system to identify and select other users who they can work with advantageously to create solutions having economic value. Such creation may take place within the S/C forum 130.

In order to maximize the potential for creation of technology and/or solutions having value, the system sponsor 100 may allow the self-selected users to utilize the solution forum 130 without outside interference. The system sponsor 100 may set up expectations or “rules of engagement” relating to the output of the solution forums 130. For example, the system sponsor 100 may require as a condition for use of the system 140 that solutions or technology generated in the solution forum 130 be first offered on a commercial basis to the system sponsor 100. Alternatively, the party first creating an explicit economic incentive in the PP/SB forum 110, may be entitled by agreement to the first option to solutions and/or technology generated in the S/C forum 130. The fewer restrictions put on the use of the system 140, the greater the likelihood that users will collaborate on an ad-hoc basis to create new solutions and technology having economic value. Additionally, the S/C forum 130 may contain a secure collaboration space 150 to allow ad-hoc S/C forum 130 users and invitees to conduct conversations that cannot be viewed by the general population and a secure database 150 where they could exchange data, information and knowledge in a secure manner.

### EXAMPLES

The following examples describes several series of events which may represent some typical event flows involved in use of the system of the present invention. It should be noted that these event flows are presented by way of example only. These examples are not comprehensive, nor does use of the system of the present invention in all cases require any or all of these events to occur, either in the order described or otherwise.

### Example 1

In this example, a System Sponsor 100 posts a problem in the PP/SB forum 110. This prompts the PP/SB forum 110 to send an alert to a registered user. Such alert is sent by virtue of programming built into the functionality of the PP/SB forum in this example. The User accesses the new posting and decides to form a team to address the problem. The User posts his intention to form a team in the PP/SB 110 posting and on the general forum 120 bulletin board and submits a team formation announcement to the general forum 120. A series of e-mail and net meeting exchanges occur among potential team members via the general forum 120. A decision to form an Ad-Hoc solution/collaboration team is made. The team registers its intent to solve the posted problem and signs the “solution provider” contract provided by the sponsor or poster. The team requests formation of a secure team space in the S/C forum 130. The team collaborates to develops a proposal for the solution and submits it to the poster. The poster accepts the proposal but requests a working prototype as proof of concept. The team uses the system resource links to engage a company to develop a working prototype for a percentage of the solution value. The team submits the final solution and prototype to the poster. The poster accepts the teams solution and pays the team and the sponsor 100 the agreed fees.

### Example 2

In this example, an organization offers to sell or license a business opportunity in the PP/SB forum 110. Several users are alerted to the offer via the PP/SB forum 110. Users start a dialog in the general forum 120, and create a work team to develop a business plan. The work team requests an Ad-Hoc teams space in the S/C forum 130 and creates a business plan. The work team shops the business plan among venture capitalists, listed is the general forum 120, and finds one who will fund a start-up. The created “Start-up” entity negotiates the purchase/license of the business opportunity from the posting organization. Start-up and posting organization pay fees to sponsor 100.

### Example 3

In this example, a user posts a patented, but uncomercialized new product in the PP/SB forum 110 and the general forum 120. Several users and organizations are alerted to the posting and an organization initiates a dialog with the poster via the general forum 120. The poster engages a lawyer, via the listing in the general forum 120, to manage the negotiation with the organization. The organization requires a peer review of the technology behind the product before making a purchase. The poster solicits the general forum 120 for qualifies experts to peer review the technology. The poster and organization identify several experts to conduct the review, the poster hires them and sets up a team space in the S/C forum 130. Results of the peer review convince the organization to purchase the new product patent. Poster and organization pay fees to the system sponsor.

While particular embodiments of the present invention have been illustrated and described, it would be obvious to those skilled in the art that various other changes and modifications can be made without departing from the spirit and scope of the invention.

What is claimed:

1. A collaboration system comprising:
i) a problem posting forum;
ii) optionally a solution bidding forum; and
iii) a general collaboration forum
iv) an ad-hoc solution team forum, wherein said ad-hoc solution team forum optionally comprises a secure data, information and knowledge exchange forum
wherein said problem posting forum, said optional solution bidding forum if present, and said general collaboration forum are operatively interconnected.

2. The system of claim 1 wherein said system is an integrated system and said problem posting forum, said optional solution bidding forum, and said general collaboration forum are separate modules within said integrated system.

3. The system of claim 1 wherein said system is a non-integrated system and said problem posting forum, said optional solution bidding forum, and said general collaboration forum are accessed through a common interface.

4. The system of claim 1 wherein said problem posting forum comprises a database, said database comprising information related to one or more posted problems.

5. The system of claim 5 wherein said posted problem is a problem selected from the group consisting of technology inoperability problems, appropriate technology identification problems, business problems, and mixtures thereof.

6. The system of claim 4 wherein said system additionally comprises a problem updating means for adding, deleting, and/or modifying said information related to said one or more posted problems.

7. The system of claim 1 wherein said problem posting forum and said general collaboration forum are linked such that a system user reviewing a posted problem can communicate with at least one other system user.

8. The system of claim 7 wherein said problem posting forum and said general collaboration forum are linked such that a system user reviewing a posted problem can exchange data with at least one other system user.

9. The system of claim 1 wherein said general collaboration forum comprises a database wherein said database comprises information selected from the group consisting of registered users, user profile information, member organizations, organization profile information, patent information, publication information, and mixtures thereof.

10. The system of claim 9 wherein a system user is alerted when a problem is posted that a predetermined selection criteria established by said system user.
